(19) United States
(12) Patent Application Publication
(10) Pub. No.: US 2024/0296828 A1
(43) Pub. Date: Sep. 5, 2024

(54) METHOD AND SYSTEM FOR TRIGGERING AN AUDIO COMPONENT CHANGE ACTION

(71) Applicant: MOTOROLA SOLUTIONS, INC., Chicago, IL (US)

(72) Inventors: CHUN WEN OOI, GEORGETOWN (MY); JIA WEI YEAP, BAYAN LEPAS (MY)

(21) Appl. No.: 18/177,154

(22) Filed: Mar. 2, 2023

(51) Int. Cl. G10L 15/00; G10L 15/02; G10L 15/18; G10L 15/20; G10L 15/28; H04R 1/08

(52) U.S. Cl. CPC G10L 15/005; G10L 15/02; G10L 15/18; G10L 15/20; G10L 15/285; H04R 1/08

(57) ABSTRACT

A method, system and computer program product for triggering an audio component change action is disclosed. The method includes analyzing audio corresponding to a period of time to identify one or more audio components of the audio that are matching to a defined set of feature parameters. The method also includes triggering an audio component change action on output of the audio, wherein effecting the audio component change action includes at least one of changing audio component volume and changing categorization of the one or more audio components, which may be based on NLP analyzation of preferences relating to volume and category of the one or more audio components.

### BACKGROUND

Environmental noise (such as, for example, wind noise, construction work noise, etcetera) can be captured concurrently with other audio components of the overall captured audio, such that the environmental noise can impact the information value of the audio being captured during a given time period. While there exist conventional solutions that aim to suppress environmental noise; such solutions may, for example, undesirably cause one or more important audio components in the environmental noise to become inaudible.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1 is a block diagram of a computing device in accordance with example embodiments.

FIG. 2 is a flow chart illustrating a computer-implemented method in accordance with an example embodiment.

FIG. 3 is a diagram of an example environment within which audio may be captured in accordance with example embodiments.

FIG. 4 is a diagram of another example environment within which audio may be captured in accordance with example embodiments.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF THE INVENTION

According to one example embodiment, there is provided a computer-implemented method that includes detecting at least one natural language phrase in first audio. The natural language phrase is describing a characteristic of a component in the first audio, and the first audio is corresponding to a first period of time. The computer-implemented method also includes analyzing, using an at least one processor, at least a portion of the first audio to achieve (in listed or reverse order) the following: i) determine a preference that the component in the first audio belong to a first category corresponding to an allowed audio component, or belong to a second category corresponding to a suppressed audio component; and ii) define a set of feature parameters representative of the component in the first audio. The computer-implemented method also includes analyzing, using the least one processor, second audio corresponding to a second period of time different than the first period of time to identify one or more audio components of the second audio that are matching to the set of feature parameters. The computer-implemented method also includes triggering an audio component change action on output of the second audio. Effecting the audio component change action includes at least one of changing audio component volume and changing categorization of the one or more audio components of the second audio from the first category to the second category, or from the second category to the first category.

According to another example embodiment, there is provided a system that includes at least one processor and an at least one electronic storage device storing program instructions. The program instructions, when executed by the at least one processor, cause the at least one processor to perform detecting at least one natural language phrase in first audio. The natural language phrase is describing a characteristic of a component in the first audio, and the first audio is corresponding to a first period of time. The program instructions, when executed by the at least one processor, also cause the at least one processor to perform analyzing at least a portion of the first audio to: determine a preference that the component in the first audio belong to a first category corresponding to an allowed audio component, or belong to a second category corresponding to a suppressed audio component; and define a set of feature parameters representative of the component in the first audio. The program instructions, when executed by the at least one processor, also cause the at least one processor to perform analyzing second audio corresponding to a second period of time different than the first period of time to identify one or more audio components of the second audio that are matching to the set of feature parameters. The program instructions, when executed by the at least one processor, also cause the at least one processor to perform triggering an audio component change action on output of the second audio. Effecting the audio component change action includes at least one of changing audio component volume and changing categorization of the one or more audio components of the second audio from the first category to the second category, or from the second category to the first category.

In some implementations, the at least one electronic storage device is further storing additional program instructions that when executed by the at least one processor cause the at least one processor to perform triggering an additional audio component change action on output of the first audio, and effecting the additional audio component change action includes at least one of another changing of audio component volume and changing categorization of the component in the first audio from the first category to the second category, or from the second category to the first category.

In some implementations, the audio component change action targets at least one background noise differently than any other background noises of a plurality of background noises in corresponding audio that includes the at least one background noise.

Each of the above-mentioned embodiments will be discussed in more detail below, starting with example system and device architectures of the system in which the embodiments may be practiced, followed by an illustration of processing blocks for achieving an improved technical method, system and computer program product for triggering an audio component change action. Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus that may be on or off-premises, or may be accessed via the cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

The term “object” as used herein is understood to have the same meaning as would normally be given by one skilled in the art, and examples of objects may include humans, vehicles, animals, etc.

Further advantages and features consistent with this disclosure will be set forth in the following detailed description, with reference to the figures.

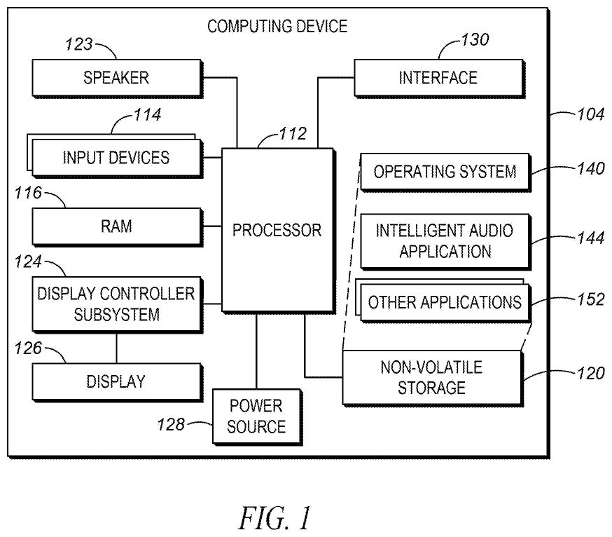

Referring now to the drawings, and in particular FIG. 1 which is a block diagram of a computing device 104 within which methods in accordance with example embodiments can be carried out. In some example embodiments, the computing device 104 is a computer system formed of a plurality of separately housed parts communicatively connected to each other; however in other example embodiments the computing device 104 is a computer system that is not necessarily physically implemented in such a manner, and may be a selected one or more of the following: a handheld device such as, for example, a tablet, a phablet, a smart phone or a personal digital assistant (PDA); a laptop computer; a smart television; and other suitable devices.

The computing device 104 includes at least one processor 112 that controls the overall operation of the computing device. The processor 112 interacts with various subsystems such as, for example, input devices 114 (such as a selected one or more of a keyboard, mouse, touch pad, roller ball and microphone, for example), random access memory (RAM) 116, non-volatile storage 120, speaker 123, display controller subsystem 124 and other subsystems. The display controller subsystem 124 interacts with display 126 and it renders graphics and/or text upon the display 126. In some examples, the display 126 may be optionally integrated into a housing of the computing device 104 (any suitable device components like, for instance, a microphone, may be optionally integrated into the housing of the computing device 104).

The computing device 104 also includes a power source 128 which provides operating power within the computing device 104. In some examples, the power source 128 includes one or more batteries, a power supply with one or more transformers, etc.

The computing device 104 also includes interface 130. The interface 130 may include hardware, software, or both providing one or more interfaces for communication (such as, for example, packet-based communication) among the computing device 104, other computing devices similar to the computing device 104, any suitable networks, any suitable network devices, and/or any other suitable computer systems. As an example and not by way of limitation, the interface 130 may include a Network Interface Controller (NIC) or network adapter for communicating with an Ethernet or other wire-based network and/or a Wireless NIC (WNIC) or wireless adapter for communicating with a wireless network. In at least one example consistent with the example embodiment of FIG. 1, the interface 130 may include a USB port to support USB-complaint communications.

In some examples, the interface 130 comprises one or more radios coupled to one or more physical antenna ports. Depending on the example implementation, the interface 130 may be any type of interface suitable for any type of suitable network with which the computing device 104 is used. As an example and not by way of limitation, the computing device 104 can communicate with an ad-hoc network, a Personal Area Network (PAN), a Local Area Network (LAN), a Wide Area Network (WAN), a Metropolitan Area Network (MAN), or one or more portions of the Internet or a combination of two or more of these. One or more portions of one or more of these networks may be wireless. As an example, the computing device 104 may be capable of communicating with a Wireless PAN (WPAN) (such as, for example, a BLUETOOTH WPAN), a WI-FI network, a WI-MAX network, an LTE network, an LTE-A network, a cellular telephone network (such as, for example, a Global System for Mobile Communications (GSM) network), or any other suitable wireless network or a combination of two or more of these. The computing device 104 may include any suitable interface 130 for any one or more of these networks, where appropriate.

In some examples, the interface 130 may include one or more interfaces for one or more external I/O devices. One or more of these external I/O devices may enable communication functionality between a person and the computing device 104 similar and/or complementary to communication functionality provided by, for instance, the input devices 114. As an example and not by way of limitation, an external I/O device may be any suitable input or output device, including alternatives more external in nature than other input devices (or output devices) herein mentioned (also, some combination of two or more of these is also contemplated). An external I/O device may include one or more sensors. Particular examples may include any suitable type and/or number of I/O devices and any suitable type and/or number of interfaces 130 for them. Where appropriate, the interface 130 may include one or more drivers enabling the processor 112 to drive one or more of these external I/O devices. The interface 130 may include one or more interfaces 130, where appropriate.

Still with reference to the computing device 104, operating system 140 and various software applications used by the processor 112 are stored in the non-volatile storage 120. The non-volatile storage 120 is, for example, one or more hard disks, solid state drives, or some other suitable form of computer readable medium that retains recorded information after the computing device 104 is turned off. Regarding the operating system 140, this includes software that manages computer hardware and software resources of the computing device 104 and provides common services for computer programs. Also, those skilled in the art will appreciate that the operating system 140, intelligent audio application 144, and other applications 152, or parts thereof, may be temporarily loaded into a volatile store such as the RAM 116. The processor 112, in addition to its operating system functions, can enable execution of the various software applications on the computing device 104.

Regarding the intelligent audio application 144, this can be run on the computing device 104 and may include code for the recording of audio captured by a microphone (e.g. one of the input devices 114). The intelligent audio application 144 may also include code for intelligent playback of recorded audio (including effecting selective output of original and/or modified versions of live, recorded and/or buffered audio via the speaker 123, for example). The intelligent audio application 144 may also include a graphical user interface displayable on, for example, the display 126. This user interface may be configured, for example, to allow a user to confirm that an audio component change action (later herein described in more detail) is desired. In at least one example, the intelligent audio application 144 also includes code that, when executed on the processor 112, configures the processor 112 to carry out one or more audio separation functions such as, for example, separating part of any given audio into speech conversation, and another part of that audio into environment noise. The implementation details of the contemplated separation functions should be readily apparent to one skilled in the art.

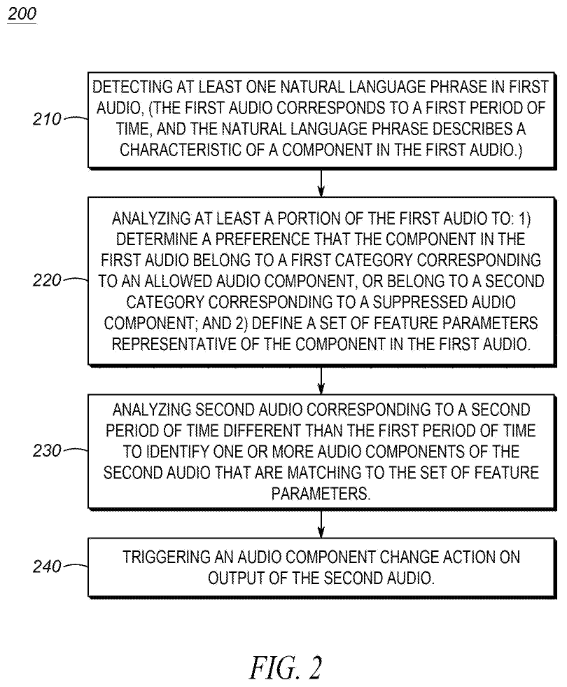

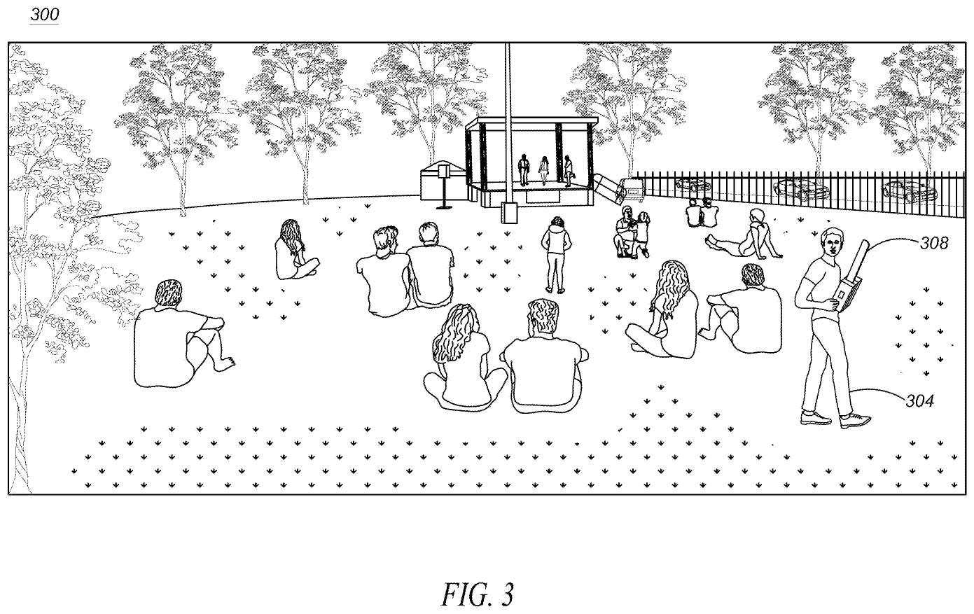

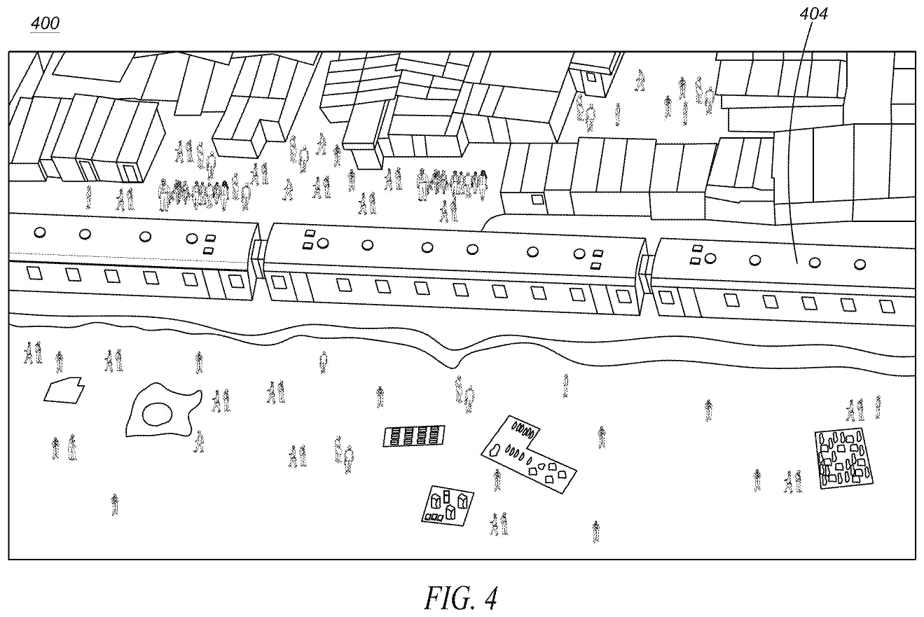

Reference is now made to FIGS. 2 to 4. FIG. 2 is a flow chart illustrating a method 200 in accordance with an example embodiment. FIGS. 3 and 4 are diagrams of example environments (a concert area 300 and a marketplace region 400 respectively) within which audio may be captured in accordance with example embodiments.

In FIG. 2, the illustrated method 200 includes detecting (210) at least one natural language phrase in first audio, where the natural language phrase is describing a characteristic of a component in the first audio, and the first audio is corresponding to a first period of time. For example, in FIG. 3 where a man 304 is illegally operating a chainsaw 308 within the concert area 300, example audio captured by a person speaking on a voice call to a concert attendee (incident bystander) could be as follows: “I cannot hear the chainsaw. Is it still being operated?” (Here the chainsaw noise is a special type of environmental noise because, as evidenced by the spoken words captured in the audio, the presence or absence of the chainsaw noise impacts situational awareness for an incident.)

As another example, in FIG. 4 where a train 404 is travelling through the marketplace region 400, example audio captured by a person, speaking on a voice call, trying to listen in on a nearby conversation that a suspect/object of interest (that is, for instance, within audible distance of the computing device 104), is engaged in, might be as follows: “The train is loud, and I cannot hear the nearby conversation.” Thus, the spoken words for this example are identifying two distinct components in the audio (one component that is enhancing situational awareness, and a second component that is detracting from situational awareness).

In some examples, the previously mentioned at least one natural language phrase in the first audio is an explicit or implicit command. Also, in some examples where an interesting portion in audio is originating from an object of interest, that object of interest may be different than a person that holds the computing device that includes (or is connected to) the microphone that captures the audio. The speech being analyzed by NLP may have any relevant information extracted from it including one or more of the following: identification detail(s) concerning the type of the object of interest generating sound, description detail(s) concerning the sound being generated (for example, ringing, rattling, speech, etcetera), verb(s) or adjective(s) related to the audio (for example, “listen to”, “too loud”, “so noisy”, “can you hear?”, “I can't hear”, “focus on”, “lower”, “increase”, “amplify”, etcetera).

Continuing on, the method 200 of FIG. 2 includes action 220 of analyzing at least a portion of the first audio to: i) determine a preference that the component in the first audio belong to a first category corresponding to an allowed audio component, or belong to a second category corresponding to a suppressed audio component; and ii) define a set of feature parameters representative of the component in the first audio. For instance, in the case of the FIG. 3 example where the analyzed portion of the first audio is chainsaw noise, a preference is that the chainsaw noise is recategorized as an allowed audio component instead of as a suppressed audio component, and this is because a computerized Natural Language Processing (NLP) analysis of the first audio is generating indication that it is important for someone to be able to hear the chainsaw noise to the extent that it exists. Also, so that the chainsaw noise can be matched to similar noise occurring in a different period of time than the period of time of the first audio, a set of feature parameters are defined for the chainsaw noise.

Now in the case of the FIG. 4 example, there are two analyzed portions of the first audio: i) train noise; and ii) nearby conversation. A preference of the nearby conversation is a recategorization as an allowed audio component; however the train noise, which is a type of repetitive background noise, has the following recategorization preference: suppressed audio component, and this is because the computerized NLP analysis of the first audio is generating indication that: firstly, it is important for someone to be able to hear the nearby conversation; however, secondly, concurrently occurring train noise is interfering with that same someone from understanding what is being said. Also, sets of feature parameters are defined for the train noise and the nearby conversation (i.e. so that these noises can be separately matched to similar noises occurring in different one or more periods of time than the period of time of the first audio).

Next the method 200 includes action 230 of analyzing second audio corresponding to a second period of time different than the first period of time to identify one or more audio components of the second audio that are matching to the set of feature parameters. For live/real time audio applications, the second period of time is later in time than the first period of time. For audio applications where recording is carried out, the second period of time may be either earlier or later in time than the first period of time. In some examples, matching can be carried out by comparing audio metadata derived from the first audio to audio metadata derived from the second audio in any conventional manner readily apparent to the skilled person. In some examples, the intelligent audio application 144 (FIG. 1) employs machine learning (for instance, one or more neural networks) to facilitate searching and matching of audio components as herein described.

Next the method 200 includes triggering (240) an audio component change action on output of the second audio, and effecting the audio component change action includes at least one of: changing i) audio component volume; and ii) changing categorization of the one or more audio components of the second audio from the first category to the second category, or from the second category to the first category. For instance, in the case of the FIG. 3 example where a match to the chainsaw noise is found in the second audio, the matched chainsaw noise portion of the second audio may have its categorization changed from the suppressed noise category to the allowed noise category, and also the volume of the matched chainsaw noise portion of the second audio may be increased. Analogously in the case of the FIG. 4 example where matches may be found to both train noise and nearby conversation in the second audio, the matched train noise and matched nearby conversation portions of the second audio may have their categorization changed to the suppressed noise category and to the allowed noise category respectively, and also the volumes of the train noise and nearby conversation portions of the second audio may be decreased and increased respectively.

In terms of increasing or decreasing volume of a component of audio, in at least one example this may include determining a target frequency range within which the identified component falls, and selectively increasing or decreasing volume just in that target frequency range.

In some examples, following completion of the actions 210 to 240 of the method 200, a reset may optionally be carried out to clear stored audio component change actions.

As should be apparent from this detailed description, the operations and functions of the electronic computing device are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etcetera, and cannot trigger an audio change component action that comes from a computerized NLP-based analysis, among other features and functions set forth herein).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending in the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through an intermediate elements or devices via an electrical element, electrical signal or a mechanical element depending on the particular context.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A system comprising:
at least one processor;
at least one electronic storage device storing program instructions that when executed by the at least one processor cause the at least one processor to perform:
detecting at least one natural language phrase in first audio, wherein the natural language phrase is describing a characteristic of a component in the first audio, and the first audio is corresponding to a first period of time;
analyzing at least a portion of the first audio to:
determine a preference that the component in the first audio belong to a first category corresponding to an allowed audio component, or belong to a second category corresponding to a suppressed audio component, and
define a set of feature parameters representative of the component in the first audio;
analyzing second audio corresponding to a second period of time different than the first period of time to identify one or more audio components of the second audio that are matching to the set of feature parameters; and
triggering an audio component change action on output of the second audio, wherein effecting the audio component change action includes at least one of changing audio component volume and changing categorization of the one or more audio components of the second audio from the first category to the second category, or from the second category to the first category.

2. The system of claim 1 wherein the at least one natural language phrase in the first audio is an explicit or implicit command, and the audio component change action is consistent with the explicit or implicit command.

3. The system of claim 1 further comprising a display and a speaker communicatively coupled to the at least one processor, and
wherein:
original or modified versions of the first and second audio are accessible for selective output from the speaker,
during operation of the display a user interface is provided thereon, and
the user interface is configured to allow a user to confirm that the audio component change action is desired.

4. The system of claim 3 wherein the system is a mobile computing device that includes a housing, and wherein the display is integrated into the housing.

5. The system of claim 4 wherein the mobile computing device further includes a microphone integrated into the housing, and the component in the first audio is generated by an object of interest within audible distance of the microphone.

6. The system of claim 5 wherein the object of interest is different than a person possessing the mobile computing device, and the changing of the categorization of the one or more audio components of the second audio is from the first category to the second category, or from the second category to the first category.

7. The system of claim 1 wherein the component in the first audio is:
a repetitive background noise, and
belonging to the first category corresponding to the allowed audio component, or belonging to the second category corresponding to the suppressed audio component.

8. The system of claim 7 wherein the repetitive background noise is one of a plurality of background noises in the first audio, and the audio component change action targets the repetitive background noise differently than any other background noises of the plurality of background noises.

9. The system of claim 7 wherein the audio component change action targets at least two different background noises of the second audio.

10. The system of claim 1 wherein the at least one electronic storage device is further storing additional program instructions that when executed by the at least one processor cause the at least one processor to perform:
triggering an additional audio component change action on output of the first audio, wherein effecting the additional audio component change action includes at least one of another changing of audio component volume and changing categorization of the component in the first audio from the first category to the second category, or from the second category to the first category.

11. A computer-implemented method comprising:
detecting at least one natural language phrase in first audio, wherein the natural language phrase is describing a characteristic of a component in the first audio, and the first audio is corresponding to a first period of time;
analyzing, using an at least one processor, at least a portion of the first audio to:
determine a preference that the component in the first audio belong to a first category corresponding to an allowed audio component, or belong to a second category corresponding to a suppressed audio component, and
define a set of feature parameters representative of the component in the first audio;
analyzing, using the least one processor, second audio corresponding to a second period of time different than the first period of time to identify one or more audio components of the second audio that are matching to the set of feature parameters; and
triggering an audio component change action on output of the second audio, wherein effecting the audio component change action includes at least one of changing audio component volume and changing categorization of the one or more audio components of the second audio from the first category to the second category, or from the second category to the first category.

12. The computer-implemented method of claim 11 wherein the at least one natural language phrase in the first audio is an explicit or implicit command, and the audio component change action is consistent with the explicit or implicit command.

13. The computer-implemented method of claim 11 wherein original or modified versions of the first and second audio are accessible for selective output from a speaker of a computing device that also includes a display upon which a user interface is provided during operation of the display, and the user interface being configured to allow a user to confirm that the audio component change action is desired.

14. The computer-implemented method of claim 13 wherein the computing device is a mobile computing device, and the display is integrated into a housing of the mobile computing device.

15. The computer-implemented method of claim 14 wherein the mobile computing device includes a microphone integrated into the housing of the mobile computing device, and the component in the first audio is generated by an object of interest within audible distance of the microphone.

16. The computer-implemented method of claim 15 wherein the mobile computing device is carried by a person, different than the object of interest, and the changing of the categorization of the one or more audio components of the second audio is from the first category to the second category, or from the second category to the first category.

17. The computer-implemented method of claim 11 wherein the component in the first audio is:
a repetitive background noise, and
belonging to the first category corresponding to the allowed audio component, or belonging to the second category corresponding to the suppressed audio component

18. The computer-implemented method of claim 17 wherein the repetitive background noise is one of a plurality of background noises in the first audio, and the audio component change action targets the repetitive background noise differently than any other background noises of the plurality of background noises.

19. The computer-implemented method of claim 17 wherein the audio component change action targets at least two different background noises of the second audio.

20. The computer-implemented method of claim 11 further comprising triggering an additional audio component change action on output of the first audio, wherein effecting the additional audio component change action includes at least one of another changing of audio component volume and changing categorization of the component in the first audio from the first category to the second category, or from the second category to the first category.
